(19) United States
(12) Patent Application Publication
(10) Pub. No.: US 2002/0174498 A1
(43) Pub. Date: Nov. 28, 2002

(54) Electric toothbrush structure

(76) Inventor: Ming-Kuei Li, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/863,302

(22) Filed: May 24, 2001

(51) Int. Cl. A61C 17/24

(52) U.S. Cl. 15/28

(57) ABSTRACT

A electric toothbrush structure comprises a block handle, power transmission device and blockhead; the power transmission device at least comprises a electric motor and transmission device, and the transmission consists of a outer gear, inner gear and connecting rod, the outer gear is connected to the shaft of the electric motor, and meshes with it inside the inner gear, the connecting rod is connected to the shaft of the inner gear, and a crooked shaft is disposed at the position of the connecting rod corresponding to the blockhead. The blockhead is connected to the block handle, it comprises a blockhead tube and circular head, the blockhead is used to accept the connecting rod, and circular head is pivoted to the front end of the blockhead, a groove, which is disposed at the bottom end of the circular head, is used to accept and connect with the crooked shaft of the connecting rod and driven by it to rotate left and right.

### TECHNICAL FIELD

The present invention relates to an electric toothbrush, and more particularly to an electric toothbrush structure, which can do deceleration and enforcement transmission, easy assembly and less malfunction.

### TECHNICAL BACKGROUND

Generally, the rotation of the blockhead of the conventional electric toothbrush is mainly driven by the power transmission mechanics inside the toothbrush to clean teeth; the power transmission mechanics of the toothbrush is a main structure design part of it. For an example, the U.S. Pat. No. 6,000,083, the patent depends the connection of a plurality of outer gears to do the power transmission, but such kind of transmission mechanics is connected simply through those gears, so, its structure not only looks complex and uneasy to be assembled, but also cause transmission malfunction easily. Therefore, how to develop a transmission mechanics of an electric toothbrush that can attains deceleration, force augmentation and compactness in structure is truly key point of this industry.

The main object of the present invention is to provide an electric toothbrush structure; it can attain a decelerating, force augmenting, accurate and forceful transmission, moreover, compact structure.

Another object of the present invention is to provide an electric toothbrush, it is convenient to assemble and uneasy to cause malfunction.

The present invention is mainly characterized in that a block handle, power transmission device and block head, wherein an outer gear is disposed at one end of a shaft projected form an electric motor, the outer gear is disposed at the inner side of an inner gear and drives the inner gear directly. The inner gear is connected to a transmission shaft, and the end of the transmission is disposed with a crooked shaft. The crooked shaft is connected to a groove at the bottom of a round head of the blockhead to enable the round head to be driven to rotate left and right, so as to attain the effects of decelerating and force augmenting transmission, convenient assembly and uneasiness in malfunction.

### BRIEF DESCRIPTION OF THE DRAWINGS

FIG. 1 is a schematic view of the present invention, showing an outside profile of an electric toothbrush.

FIG. 2 is an explosive view of the present invention, showing an inner structure of an electric toothbrush.

FIG. 3 is a perspective view of the present invention, showing an inner structure of an electric toothbrush in assembly.

FIG. 4 is a schematic view of the present invention, showing a power transmission mechanism of an electric toothbrush structure.

FIG. 5 is a schematic view of the present invention, showing a blockhead of an electric toothbrush structure.

### DETAILED DESCRIPTION OF THE PRESENT INVENTION

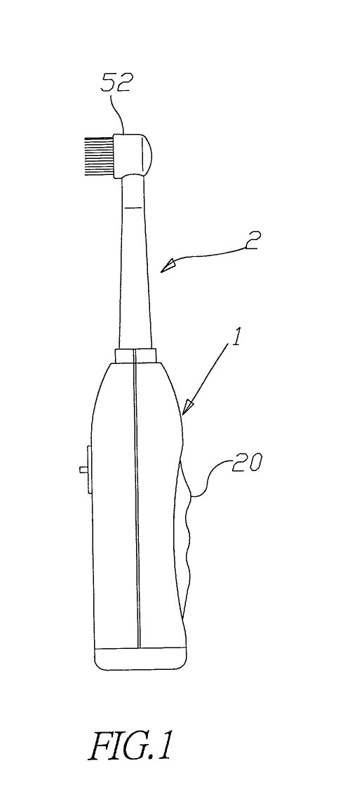

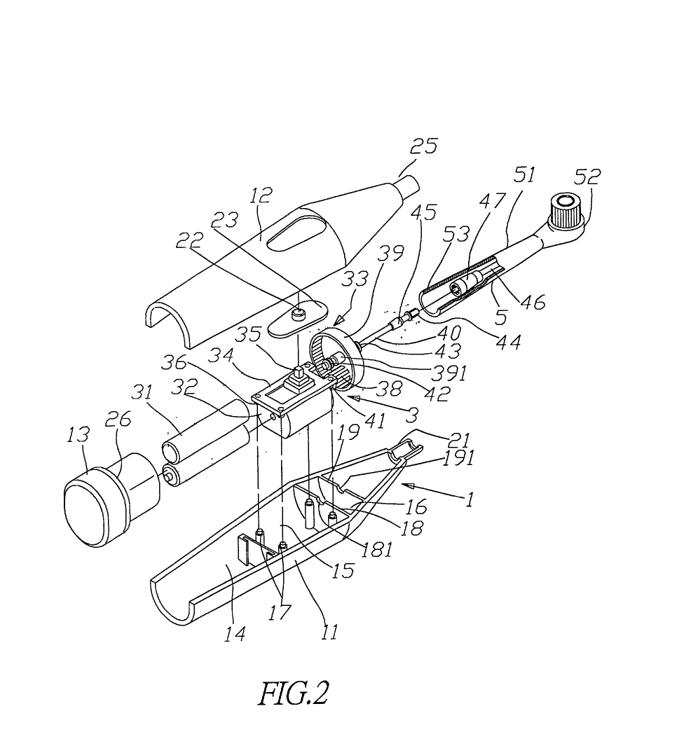

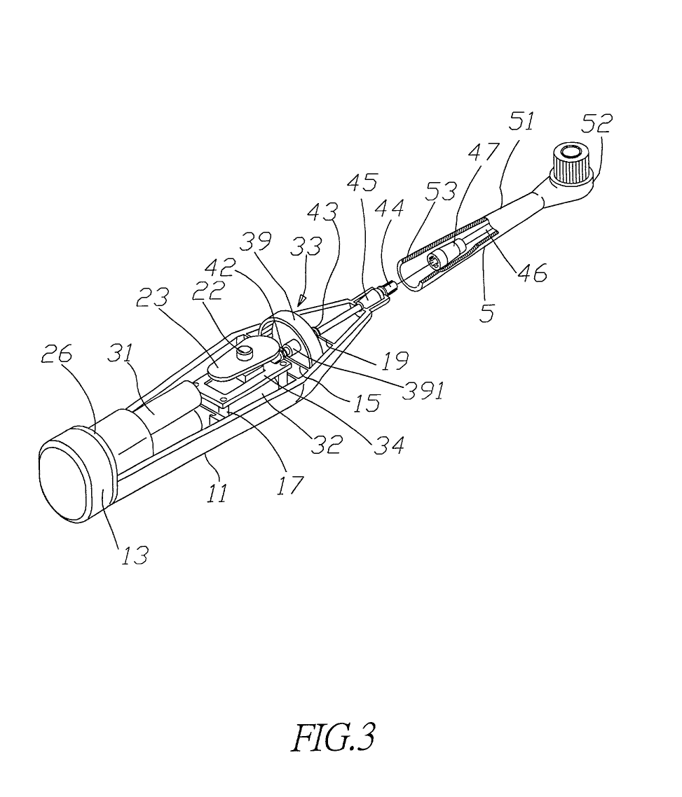

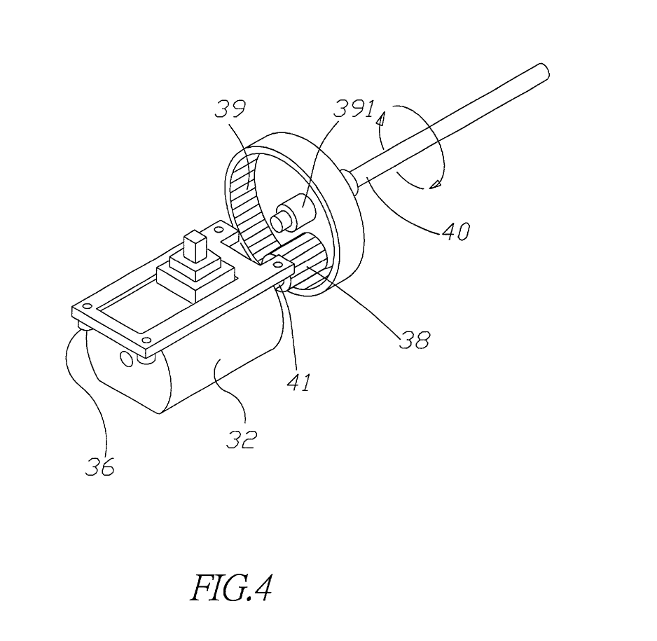

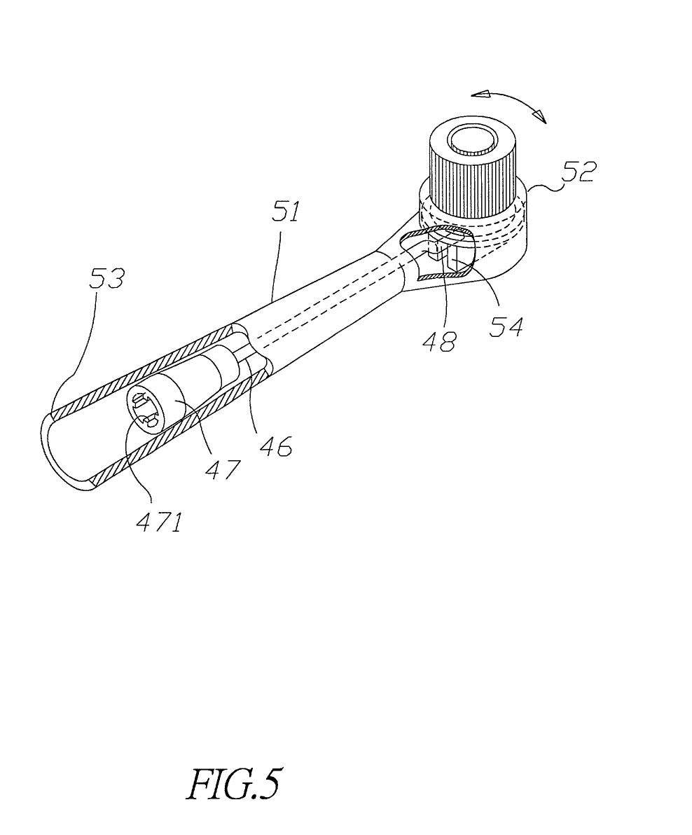

Please refer to FIG. 1 and 2, an electric toothbrush structure of the present invention comprises a block handle 1, power transmission device 3 and blockhead 5, the block handle 1 comprises a rear housing 11, front housing 12 and rear cover 13. A battery room 14, electric motor room 15 and transmission room 16 are disposed in the rear housing 11. Hollow pillars 17 are disposed at the four corners of the electric motor room 15, and a first supporting plate 18 and second supporting plate 19 are disposed at two sides of the transmission room 16, A first groove 181 and second groove 191 are disposed at the first supporting plate 18 and second supporting plate 19 respectively. Furthermore, a soft rubber and wave type grasp is disposed at the backside surface of the rear housing 11 (as shown in FIG. 1); a noose 21 is disposed at the front end of the rear housing 11. A button 22 and button cover 23 are installed on the front housing 12, that is buckled up with the rear housing 11, position pillars (not shown in the drawings) are disposed at places corresponding to the hollow pillars 17 of the rear housing 11. Besides, a noose 25 is disposed at the front end of the rear housing 12. The rear cover 13, around which an waterproof O type rubber ring 26 is installed, is wedged into the end of the combination of the front housing 11 and front housing 12. The power transmission device 3 comprises two suits of battery 31, electric motor 32 and transmission device 33, which are installed in the battery room 14, electric motor room 15 and transmission room 16 of the rear housing 11 respectively. The electric motor 32 further comprises a bracket 34, switch 35 and shaft 41, short fixed hollows 36 are disposed at positions of the bracket 34 corresponding to the hollow pillars 17 if the rear housing 11, they are wedged by the self tapping screw to fixe the fixed hollows 17 on position electric motor 32, the switch 35 is connected to the button 22 of the front housing 12 to be operated by it. The transmission device 33 includes a outer gear 38, inner gear 39 and first connecting rod 40 (please refer to FIG. 3 and 4 at the same time), the outer gear 38 is disposed at the end of the shaft 41 of the electric motor 32, and is positioned inside the inner gear 39 and meshes with it. The inner gear 39 comprises an inner gear shaft 391; the inner gear shaft 391 is directly connected to the first connecting rod 40. Besides, a first bearing sleeve 42 and second bearing sleeve 43 are installed at the two sides of the inner gear shaft 391, the first and second bearing sleeves 42 and 43 are wedged in to the first and second grooves 181 and 191 of the supporting plates 18 and 19, they are used to support transmission device 33. A transmission head 44 is disposed at the front end of the first connecting roc 40, an outer sealing rubber 45 is disposed between the transmission head 44 and first connecting rod 40, and it provides a waterproof function. Moreover, the transmission device 33 consists of a second connecting rod 46, and the second connecting rod 46 is installed in the blockhead 5, it is used to change the blockhead 5 conveniently. Now, refer to FIG. 5 too, a transmission head 47 and crooked shaft 48 are disposed at the both ends of the second connecting rod 46. The transmission head 47 is hollow, and a longitudinal rack 471is disposed therein, it is used to be convenient for the transmission 44 of the first connecting rod 40 to be inserted therein to connect transmission. The blockhead 5 consists of a blockhead tube 51 and round head 52, the blockhead 51 is used to receive the second connecting rod 46, a blockhead tube 53 is disposed at its one end relative to the blockhead 1, it can be buckled up with the nooses 21 and 25 after the rear housing 11 and front housing 12 are combined so as to be benefited in the change of blockhead 5. The round head 52 is pivoted to the front end of the blockhead tube and can rotate, a groove 54 is disposed at the bottom thereof (please refer to FIG. 5, it is used to received and connect with the crooked shaft 48 of the second connecting rod 46.

When power is on, the outer gear 38 of the transmission devise will transmit the inner gear 39 to rotate the first connecting rod 40, but because the transmission head 44 is wedged in and connects with the longitudinal rack 471 in the transmission 47, the second connecting rod 46 will also be rotated. Finally, the crooked shaft 48 of the second connecting rod 46 drives circular head to rotate left and right and start the teeth cleaning.

The electric toothbrush structure of the present invention at least has the following effects:

1. The electric toothbrush structure of the present invention can get deceleration and force augmentation transmission effectively and is compact, accurate in transmission and forceful.

2. The transmission mechanism design of the present invention is compact, so it is convenient in assembly and uneasy to cause malfunction.

3. The present invention is conformed to ergonomics, it is convenient to grasp and use, as well as the change of the blockhead.

What is claimed is:

1. An electric toothbrush structure, comprising a block handle, power transmission device and blockhead; an electric motor room and transmission room being disposed in said block handle, and a button being disposed thereon; said power transmission device at least comprising a electric motor and transmission devices, which are installed in said electric motor room and transmission room respectively, said electric is activated by said button; said transmission device comprising a outer gear, inner gear and connecting rod, wherein said outer gear is directly disposed at the end of a shaft of said electric motor, and is positioned inside said inner gear and meshes therewith, the connecting rod is directly connected to a shaft of said inner gear longitudinally, and a crooked shaft is disposed at a position of said connecting rod corresponding to said blockhead; said blockhead being connected to said block handle, comprising a blockhead tube and circular head, said blockhead tube being used to receive said connecting rod, and the circular head being pivoted to a front end of blockhead tube and being rotatable, a groove be disposed at a bottom end thereof, being used to accept and connect with said crooked shaft of said connecting rod, and being moved to rotate left and right thereby.

2. The structure of claim 1, wherein said block handle comprise a rear housing, front housing and rear cover, and can be combined together with each other.

3. The structure of claim 2, wherein said a battery room, electric motor room and transmission room are disposed in said rear housing.

4. The structure of claim 3, wherein hollow pillars are disposed at four corners of said electric motor room.

5. The structure of claim 3, wherein a first supporting plate and second supporting plate are disposed at the two sides of said transmission room.

6. The structure of claim 5, wherein a first and second groove are disposed on said first and second supporting plates respectively.

7. The structure of claim 2, wherein a soft rubber and wave type grasp is disposed at the backside surface of said rear housing.

8. The structure of claim 2, wherein a couple of nooses are disposed at the front end of said rear and front housings.

9. The structures of claim 2, wherein a button and button cover are disposed on said front housing.

10. The structure of claim 2, wherein position pillars are disposed at the positions of the front housing corresponding said hollow pillars of said rear housing so as to wedge and fix each other.

11. The structure of claim 2, wherein said rear housing is covered at the end of the combination of said rear housing and front housing, and a O type ring is disposed thereon.

12. The structure of claim 1 or 2, wherein said power transmission device comprises a battery installed in said battery room of said power transmission device.

13. The structure of claim 1, wherein said electric motor has a bracket, short hollow pillars are disposed at positions of said bracket corresponding to said hollow pillars of said rear housing to be used to wedge into said hollow pillars to position said electric motor.

14. The structure of claim 1, wherein said electric motor has a switch, said switch is connected to said button of said front housing to be operated thereby.

15. The structure of claim 1 or 6, wherein a first and second bearing sleeves are disposed at the two sides of a shaft of said inner gear, said first and second bearing sleeves are wedged into a first and second grooves of said first and second supporting plate to be used for supporting said transmission device.

16. The structure of claim 1, wherein said connecting rod consist of a first connecting rod and second connecting rod, said first connecting is disposed in said block handle, and said connecting rod is disposed in is disposed in blockhead.

17. The structure of claim 16, wherein a transmission head is disposed at the front end of said first connecting rod.

18. The structure of claim 16, wherein a transmission head is disposed at the position of said second connecting rod relative to said first connecting rod.

19. The structure of claim 18, wherein said transmission head is hollow and a longitudinal rack is disposed therein.

20. The structure of claim 8, wherein a blockhead tube that is disposed at the position of said blockhead relative to said block handle can be wedged into said nooses after said rear housing and front housing are combined together to be benefited in change said blockhead.

21. The structure of claim 17, wherein an outer sealing rubber is disposed between said first connecting rod and said transmission head.
